(19) United States
(12) Patent Application Publication
(10) Pub. No.: US 2018/0133645 A1
(43) Pub. Date: May 17, 2018

(54) METHOD FOR CLEANING POLLUTING COMBUSTION FUMES

(71) Applicant: Cinovatec S.A. DE C.V., Jalisco (MX)

(72) Inventor: Germán CASTAÑEDA FONSECA, Jalisco (MX)

(21) Appl. No.: 15/537,792

(22) PCT Filed: Dec. 18, 2015
(86) PCT No.: PCT/MX2015/000219

§ 371 Date: Jun. 19, 2017

(30) Foreign Application Priority Data
Dec. 19, 2014 (MX) MX/A/2014/016008

(51) Int. Cl. B01D 53/50; A62D 3/40; F23J 15/00; B01D 53/77; B01D 53/73

(52) U.S. Cl. CPC B01D 53/502; A62D 3/40; F23J 15/003; B01D 53/504; B01D 2251/404; B01D 53/73; B01D 2258/0291; F23J 2215/20; B01D 53/77

(57) ABSTRACT

A process for cleaning non-condensable pollutant fumes, produced by a combustion; said system comprises: concentrating the non-condensable polluting fumes; mix the contaminating fumes with an alkaline mixture and water vapor; injecting the above mixture into a post-combustion furnace; incinerating said mixture into the oven; conducting the resulting combustion flow by means of a reaction duct without heat, wherein the solid particles will be joined to the solid particles of the alkaline mixture, leaving the air free; separating the formed agglomerates from the gaseous part; and recovering the precipitated agglomerates.

### TECHNICAL FIELD OF THE INVENTION

The present invention has its technical field in the Mechanics, Electrical, Chemistry and Ecology; as it provides a process for cleaning non-condensable polluting fumes produced by combustion.

### BACKGROUND OF THE INVENTION

The use of alkaline substances for the cleaning of atmospheric pollutants, is now well known, however, these technologies, are not in practice, as the problem of environmental pollution is becoming more difficult to control, the current technologies, are deficient or are made at the experimental level.

For example, in patent document ES2153409, it describes a process for treating effluents produced in a domestic and/or industrial waste incineration, where the process starts with neutralizing in a reactor, the acid gases contained in the hot fumes which come from the incineration, with a basic unsaturated aqueous solution (alkali metal carbonate, specifically calcium carbonate), which is sprayed and injected at the same time as the hot fumes inside the reactor where the water evaporates rapidly and the carbonate of alkali metal is crystallized into particles of about 1 micron; condensing and absorbing heavy metals; and separating by filtration the solid particles produced by the neutralization reaction, the reagent excess and the volatile ash; which can be washed to obtain a solid off of contaminating soluble salts, or be melted and cooled to have a vitrified solid, where the contaminating substances are trapped. In this case, an additional step is required to wash the precipitated particles, or melt them to leave them in an environmentally harmless state.

For its part, patent document ES2020810 discloses a method for removing, by means of rinsing, sulfur, nitrogen and carbon acids from the hot gas of a cement-making furnace. The method consists in reacting the contaminated hot gas with an aqueous suspension containing oxides, hydroxides, or carbonates of alkali and alkaline earth metals; to form a solution containing soluble salts and insoluble precipitated compounds. Recover the precipitate from the solution; evaporate the solution to recover the form of dissolved salts and expel the already clean gas. One limitation of this method is that it is intended only for pollutants that come from a cement industry, so for other types of contaminants it will have to be modified, especially for those gases that require post-combustion.

The use of other types of salts has also been proposed, as in patent U.S. Pat. No. 4,458,095, which describes the use of copper and zinc salts to reduce the impurities of sulfur and nitrogen during the pyrolysis of plastic waste and rubber to hydrocarbons. Where the improvement comprises the application of at least about 1% by weight of salts, based on the weight of the residues, preferably chloride or carbonate, zinc or copper salts.

In order to provide a solution to the aforementioned drawbacks, a method was developed for cleaning the non-condensable polluting fumes, which come from a combustion.

### BRIEF DESCRIPTION OF THE DRAWINGS

FIG. 1. Is a top perspective view of a pyrolysis reaction plant, comprising a combustion-flue cleaning apparatus of the present invention.

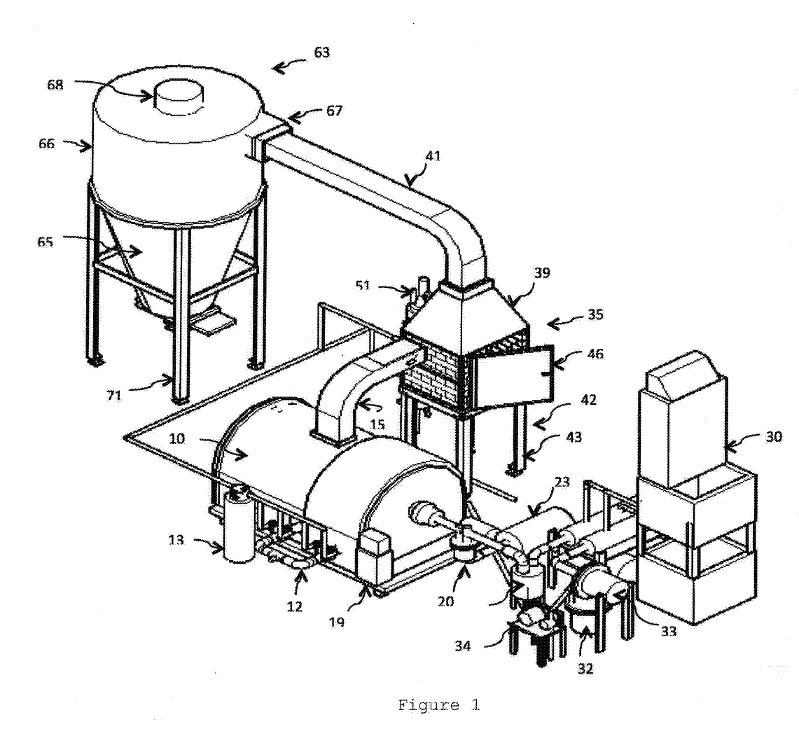

FIG. 2. Is a right side view of the pyrolysis reaction plant, comprising the combustion flue cleaning equipment of the previous figure.

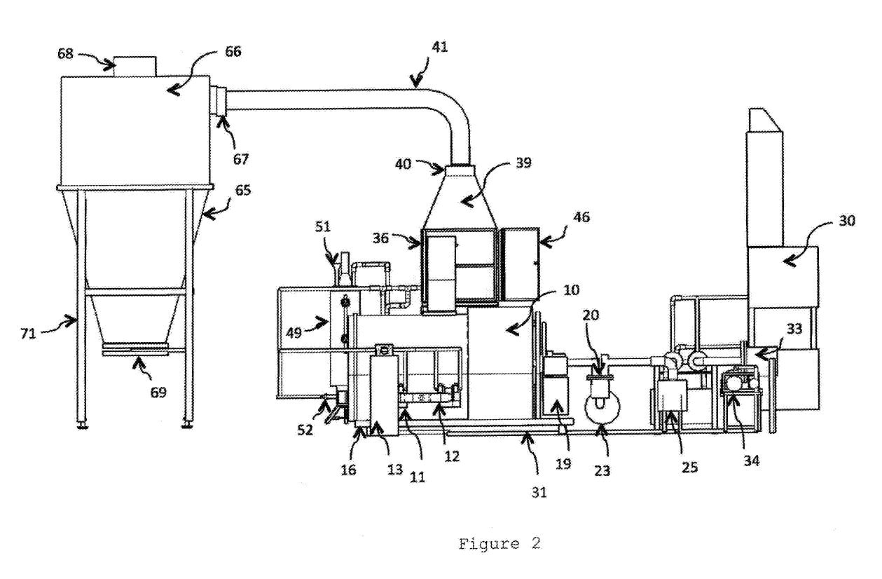

FIG. 3. Is a left side view of the pyrolysis reaction plant, comprising the combustion flue cleaning apparatus of FIG. 1.

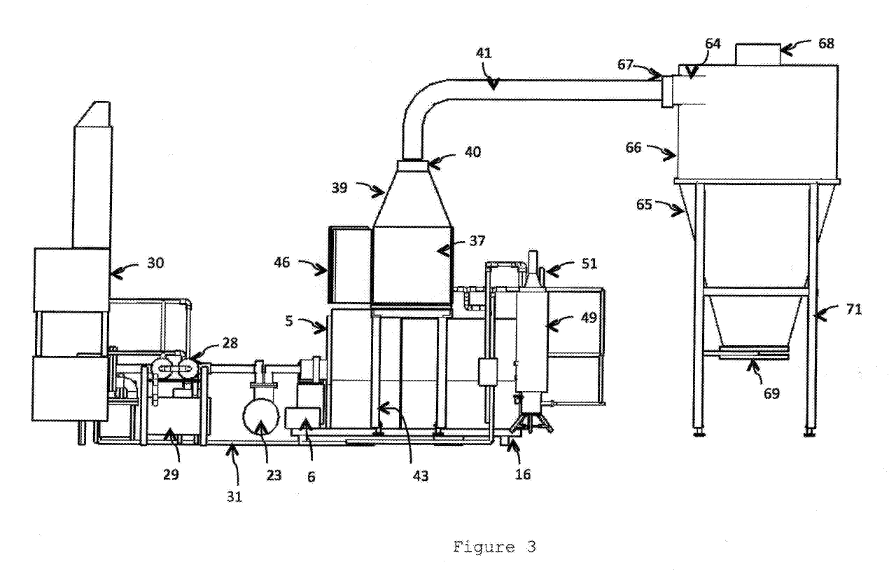

FIG. 4. Is a front view of the pyrolysis reaction plant comprising the combustion-flue cleaning apparatus of FIG. 1.

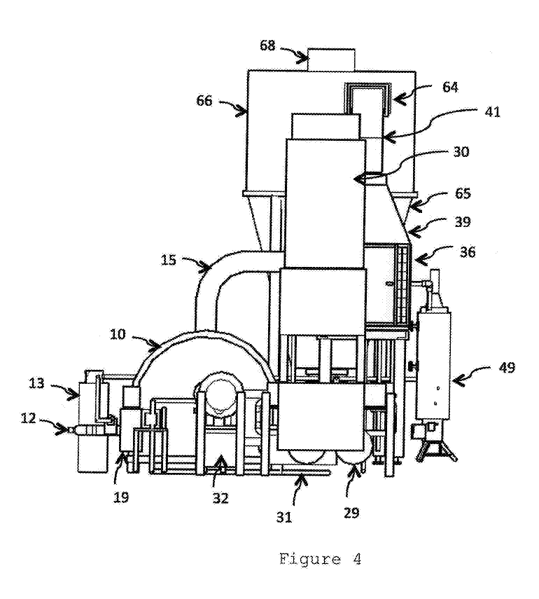

FIG. 5. Is a top view of the pyrolysis reaction plant, comprising the flue-gas cleaning apparatus of FIG. 1.

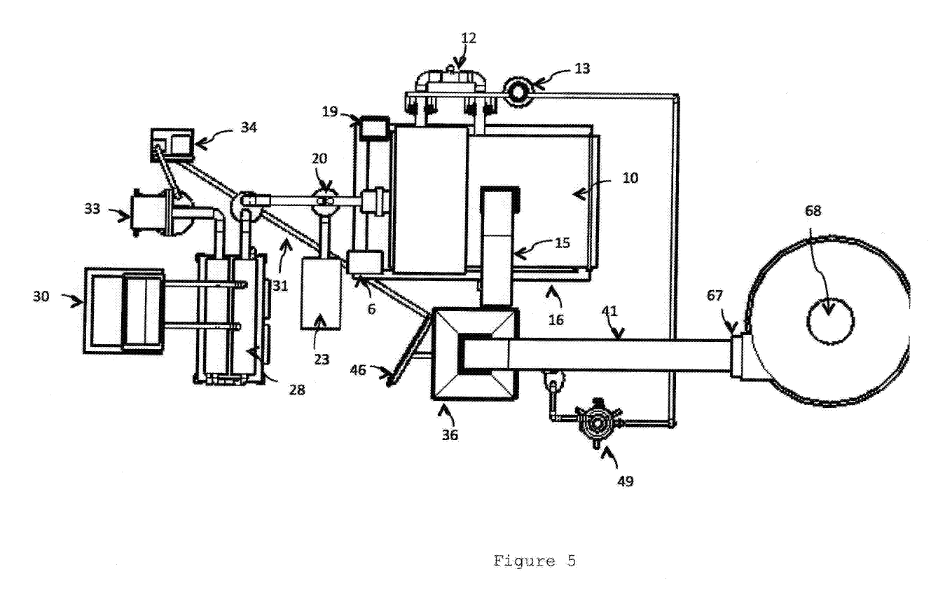

FIG. 6. Is an exploded perspective view of the pyrolysis reactor of the pyrolysis reaction plant.

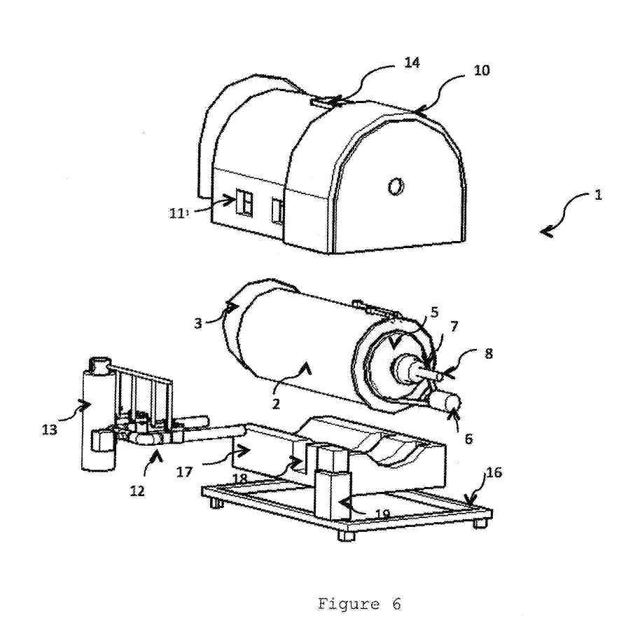

FIG. 7. Is a perspective view of the machines, apparatus and devices, for separating the products generated by the pyrolysis reaction.

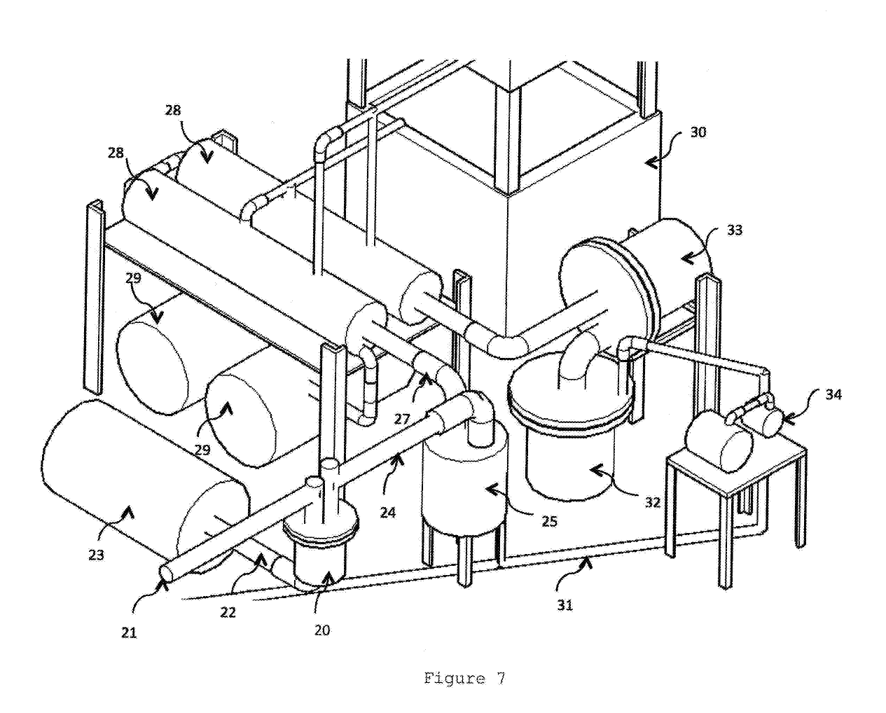

FIG. 8. Is an exploded perspective view of the afterburner of the flue gas cleaning equipment according to the present invention.

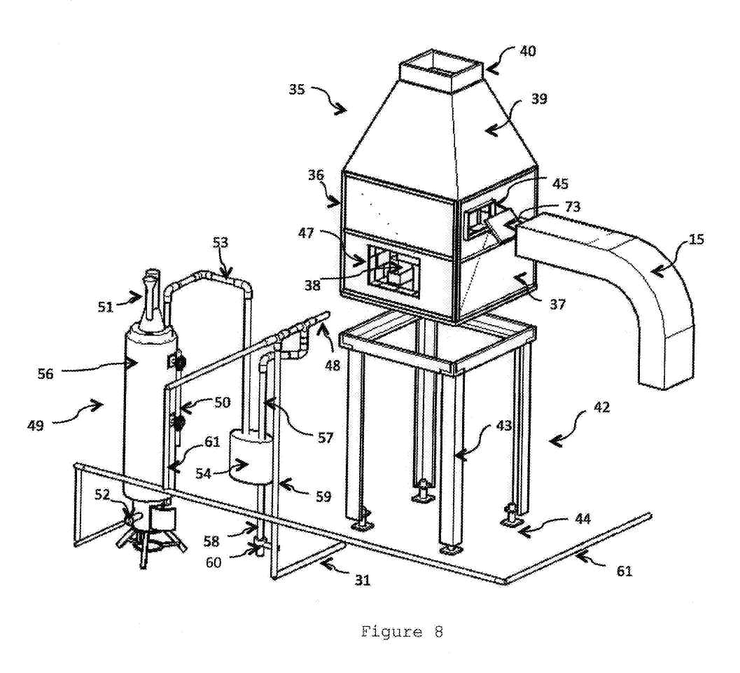

FIG. 9. Is a rear perspective view of the post-combustion furnace and a steam generator, which are part of the combustion-flue cleaning equipment of the present invention.

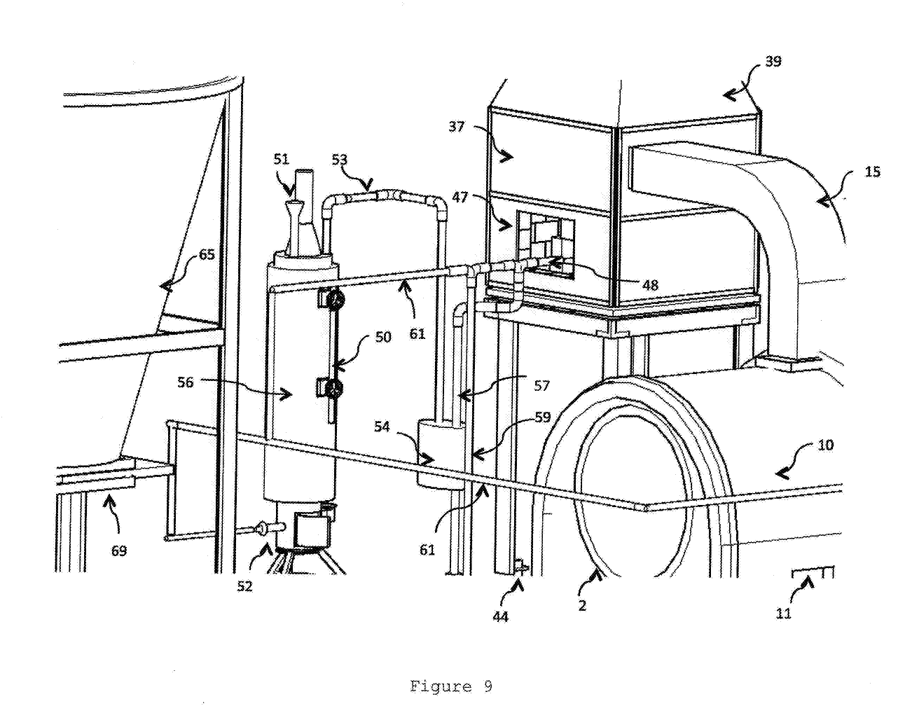

FIG. 10. Is a perspective exploded perspective view of said afterburner.

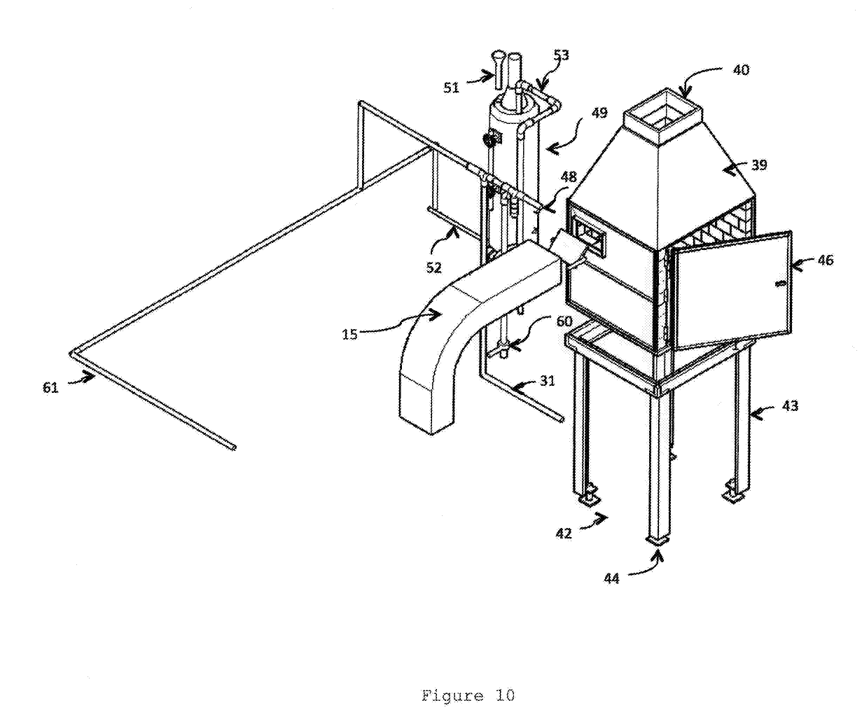

FIG. 11. Is an exploded perspective view of a solids precipitator of the combustion flue cleaning equipment according to the present invention.

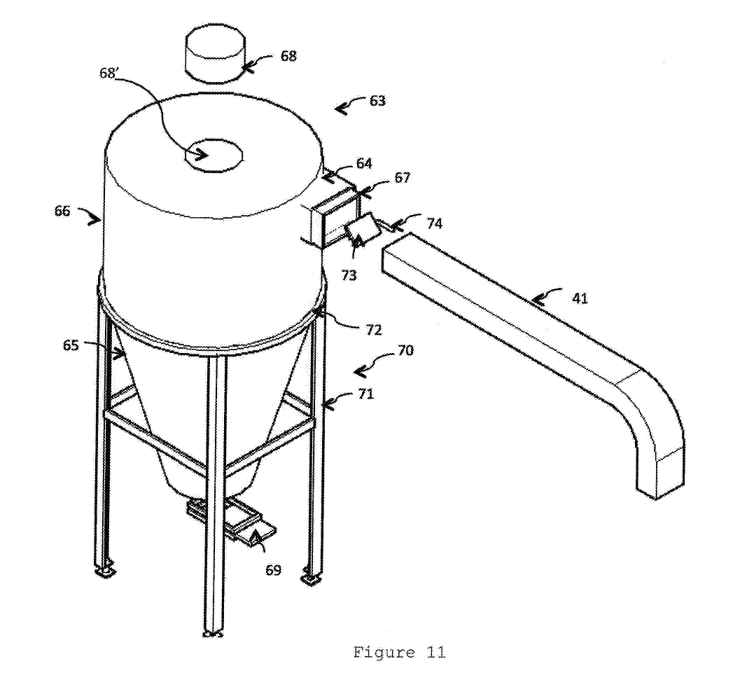

### DESCRIPTION OF THE INVENTION

The invention relates to a process for the cleaning of non-condemnable pollutant fumes from a combustion/incineration; however, those fumes resulting from a thermolysis, pyrolysis and gasification reaction may also be cleaned. Generally, the fumes to be cleaned are those that are not condensable and, burning; as they will be treated by means of subsequent combustion.

Accordingly, the process of the present invention can be applied in those installations and processes that perform combustion/incineration, pyrolysis, thermolysis and gasification, producing atmospheric emissions (acid gases,

Persistent Organic Compounds -COPs such as dioxins and furans, oxides of Nitrogen, sulfur dioxide, hydrogen chloride, particulate matter, volatile organic compounds, heavy metals such as cadmium, mercury, lead and hydrogen sulfide); solid wastes (inert mineral ash, inorganic compounds), among others.

The most common processes where combustion is carried out are, for example, a cement plant, a thermoelectric plant, plants dedicated exclusively to waste incineration; among others.

The process for cleaning non-condensable pollutant fumes, produced by combustion/incineration, thermolysis, pyrolysis and gasification, preferably of the present invention, comprises the following steps:

Concentrate non-condensable contaminant fumes, by conventional means, as used in some plants that generate them; such as a solid trap (32), a vacuum pump (34) and a pipe for conducting such fumes to a post-combustion furnace.

Mixing the non-condensable and burning pollutants with an alkaline mixture and steam with the aid of a steam generating apparatus (49); wherein the alkaline mixture may comprise a combination of calcium hydroxide (CaOH) and sodium bicarbonate (NaCO₂), or instead of NaCO₂, caustic soda (NaOH) may be used, but the latter is more corrosive to the components of the equipment used, whereby NaCO₂ is preferred. The concentration of the alkaline substances CaOH: NaCO₂ or NaOH, is 3:1.

Injecting the above mixture into a combustion furnace (35), configured to carry out total combustions, preferably.

Incinerate the mixture in the combustion furnace until the mixture is completely incinerated.

Conduct the resulting combustion flow through a duct without heat, where the solid particles will be joined to the solid particles of the alkaline mixture leaving the air free. This flow can be conducted by a reaction duct connected to the post-combustion furnace, where the already incinerated flow, as it advances in the flow, decreases its temperature and causes a chemical reaction of the pollutants with the alkaline substances, in such a way that a separation of the fractions that make up the pollutant fumes is carried out, where the solid particles are trapped or adhered to the Ca and/or Na of the alkaline substances, thus decontaminating the gaseous part. In this way solid agglomerates are formed which can be easily collected.

Separating the agglomerates formed in the above step from the gaseous part with the aid of a solids precipitating apparatus (63); where the agglomerates fall by gravity and are collected in a vessel, and the decontaminated gaseous part is released to the environment, since it is mostly oxygen.

Recover the precipitated agglomerates, in a conventional manner, which can be deposited or treated, according to the purpose that is desired.

The above-described method can be carried out by the use of a device for cleaning non-condensed pollutant fumes from combustion/incineration; wherein said equipment comprises a post-combustion furnace (35), for burning the non-condensed contaminating fumes, which come from a combustion/incineration; the furnace body (36) is made from materials resistant to combustion/incineration temperatures, for example refractory brick (38), the walls of which are externally sheathed with metal sheets (37) and the top face is open. A bell-shaped part (39), with an upper opening (40), made of metal foil, seals the upper face of the furnace body (36). The post-combustion furnace (35) is preferred to be at a height suitable for interacting with the other components, for example, it may be mounted to a structure (42) and preferably has means (44) for regulating the height of said furnace.

In one of the side faces of the body (36) of the furnace 35 there is provided a perforation (45) for receiving the external heat generated by a pyrolysis chamber (2) covered by a housing (10); for this purpose, a duct (15) is connected in said perforation (45) and in a drilling (14) that the case has (10). In such a way that the heat concentrated in said casing (10) is led into the afterburner (35), through the duct (15).

In another side face of the body (36) of said furnace (35), a perforation (47) is provided to receive the non-condensed contaminated fumes produced inside the pyrolysis chamber (2), wherein said fumes Have been separated and condensed by the apparatus of a combustion system, for example pyrolysis; whereby this pyrolysis chamber (2) is an example of a source which supplies the polluting fumes to be cleaned. Therefore, a main injection tube 48 is placed in the perforation 47, which in turn branches into several pipes, which provide the non-condensed contaminating fumes for treatment. These pipes are described below.

One of the side faces of the body (36) of the furnace (35) is fully open, for maintaining the interior of the furnace; therefore, a hinged door (46) is provided for sealing said face.

The contaminating smoke cleaning equipment of the present invention has a steam generator (49) for steam mixing with a mixture of alkaline substances, preferably located near the face, of the furnace (35) having the perforation (47) where the non-condensed contaminating fumes are injected. Said steam generator 49 is formed of a vertically disposed cylindrical body (56), to which ducts are provided to receive water from some source of water; a water level indicator (50); a hopper 51 at its upper end where the alkaline mixture is added, for example as calcium hydroxide (CaOH), sodium bicarbonate (NaCO₂) and/or caustic soda (NaOH); a burner (not shown) at its bottom, wherein a tube (52) feeds fuel gas to produce heat, until the water inside the cylindrical body (56) is converted into steam and mixed with the alkaline mixture; and a tube (53) connected in the upper part of the body (56) moves the mixed steam to a water-removing apparatus (54) in order to remove the excess of this liquid; whereby said water eliminator (54) is a closed container, which in its lower part has a vertical tube 58 with a valve 60, to allow the passage of water which condenses and leaves the water eliminator (54).

While the fraction still remaining in water vapor mixed with the alkaline mixture, is injected into the end of the main injection tube 48, by means of a tube (57), located at the top of the water eliminator (54).

A pipe (31) is connected between a vacuum pump (34), a pyrolysis combustion system or reaction system, and the main injection pipe (48), but at a position prior to the connection of the pipe (57); in such a way that the polluting fumes from the combustion are combined with the water vapor contained in the alkaline mixture. Said main injection tube (48) is connected to the line (61) from a fuel gas tank (13) located in the pyrolysis reaction chamber to inject gas into the non-combustion polluting fumes to make them burning. Therefore, when the fumes to be cleaned are burned, the application of said gas is not necessary. Therefore, with this equipment, the cleaning of contaminants, burning and non-burning fumes can be made.

The equipment in question also comprises a solids precipitating apparatus (63) disposed vertically towards one side of the afterburner (35); said precipitating apparatus (63) is formed of a lower truncated conical body (65), which is hollow and open in its two openings; where its major opening is projected upwards, to position a cylindrical body (66) open on its underside and closed on its upper face, but with a central hole (68′), to place a chimney (68) therein. A side opening (64) is provided on the side face of the cylindrical body (66), preferably at the top, by this mouth (64) where the already incinerated polluting fumes coming in from the afterburner (35) are entering. That is why this solids precipitator (63) is placed at a certain height to allow the precipitation of particles by gravity.

A reaction duct (41) connects the afterburner (35) to the precipitating apparatus (63); where one end of the duct (41) is connected to the upper opening (40) of the furnace (35) and the other end to the side mouth (64) of the precipitating apparatus (63).

In the reaction duct (41), it is where the physico-chemical reactions of the non-condensable pollutants occur, since as the temperature of the reagents goes down, that is, that each of the reactions will be given to different temperature and in a consecutive order, in its path from the afterburner (35) to the precipitating apparatus (63). In this way, non-condensable contaminant fumes are cleaned as the solid particles that accompany the fumes are bound to calcium or sodium and are forced to precipitate. In the case of nonmetals, such as sulfur, they form a calcium compound; and in the case of chlorine forms bonding with sodium. So the hot flow coming from the furnace (35), which is a mixture of dry steam, alkaline substances and non-condensate contaminated fumes from the pyrolysis, by the duct (41) its temperature is lowered; and upon reaching the precipitating apparatus (63), the gaseous fraction is already free of contaminants and is released into the atmosphere by means of the chimney (68); while the solid part, which is mostly calcium sulfate and sodium chloride formed by reacting the alkaline substances (CaOH, NaCO₂ and/or NaOH) with the solid particles contained in the non-condensed fumes, precipitates to the bottom of the precipitating apparatus (63) exiting through the lower perforation and are collected by a vessel (69). This is how the non-condensed fumes from a combustion/incineration, pyrolysis reaction, thermolysis, and/or gasification are treated, which are currently difficult to treated in such a way that the air is free of contaminating solids and can be released to the environment without any damage problems and the solids are recovered with an alkaline substance and then reprocessed by other procedures as desired.

It should be added that both the heat recovery duct (15), such as the reaction duct (41), have in their interior a damper (73), with a lever (74), which allows them N open or close to regulate the amount of fluids.

### EXAMPLES

The following examples illustrate one of the many embodiments for carrying out the invention; therefore, they should not be considered as limiting the present invention.

### Example 1

### Anhydrous Pyrolysis Plant Comprising a System for the Reduction of Non-Condensed Contaminating Substances of the Present Invention.

The equipment of the present invention was applied in a pyrolysis plant and according to the aforementioned figures said pyrolysis plant was formed from a pyrolysis reactor (1), which in turn was constituted of a pyrolysis chamber (2) arranged horizontally, which has a vertical hatch (3), which closes the entrance of the material to be processed, in this case pieces of tire were used; said pyrolysis chamber (2) is rotatable about its own horizontal axis, to optimize thermal transfer; so that to their ends they were provided with bearings that were mounted on supports; and a main gear (5) was connected to a reduction motor (6) by means of a chain (7); therefore, said chamber (2) was mounted on a structure (not shown) which allowed it to rotate horizontally on its own axis. In addition, the chamber (2) was provided with an outlet pipe (8) at the end where the main gear (5) is to blow black fumes, light oils, heavy oils, etc., caused by pyrolysis.

It is important to mention that the pyrolysis chamber (2) was enclosed with a tunnel-like metal casing (10), which covered the upper part of said chamber (2); the metal casing was covered internally by a layer of thermal material, which allowed it to concentrate and conserve more time the heat. This casing (10) has, on one of its side faces, at least two square holes (11), for introducing gas burner tubes (12), for heating the pyrolysis chamber (2); whereby a fuel gas tank (13) was added to provide said gas for heating the pyrolysis chamber (2). A square perforation with a nozzle (14) was made in the upper face of the housing (10), where a heat recovery duct (15) was inserted.

The reactor has a base (16) made of rectangular welded seams on which a refractory brick “bed” (17) has been mounted, configured to hold the chamber (2) horizontally with its housing (10). Said bed had cavities (18), to introduce the gas burner tubes (12) therein.

A control panel (19) for monitoring and inspection of the process was placed on the side of the pyrolysis chamber (2); this control panel consisted of: a switch on/off switch, a thermometer to check the temperature inside the pyrolysis chamber (2), a button to turn a vacuum pump on and off (34), a knob to regulate the amount of gas in the burners, a button to turn on and off a cooling tower (30), level indicators in heavy and light oil tanks.

A conventional catalyst (20) was added to separate the heavy oils, which has: a first tube (21), which is connected to the smoke and oil outlet pipe (8); a second tube (22) carrying the heavy oils to a heavy oil tank (23) where they are temporarily stored and a third tube (24) which carries the light fumes and oils to a water separator (25), which has a valve through which the water separates and an outlet tube (27), which conducts the light fumes and oils to a pair of capacitors (28), located on the top of a metal shelf, these condensers are responsible for Liquefy the light oils and then drop them into light oil tanks (29), located in the lower part of the metal shelf, where these products are temporarily stored.

A cooling tower (30), which is supplied with water from the municipal grid, is connected to the condensers (28) to lower the temperature of the light oils and to precipitate them into tanks (29) for light oils.

A solids trap (32) is connected to the tubing receiving material from a water seal (33) located after the capacitors (28). In this solid trap all particles (unprocessed fragments, pieces of rust or impurities that could affect) are captured to avoid damaging the vacuum pump (34). The water seal device (33) is useful to allow passage of the uncondensed contaminant fumes and prevent the return of fire to the pyrolysis chamber (2).

The vacuum pump (34) is connected to the solid trap (32). The vacuum pump is responsible for extracting the residual fumes (non-condensed gases) from the oil separation step, where said residual or non-condensed fumes are led by means of a pipe (31) to the cleaning equipment of said pollutant fumes (49) and a precipitating apparatus (63). The invention relates to a method for the preparation of non-condensed non-condensed products of the present invention, which in this example was mainly composed of a post-combustion furnace (35), a steam generating apparatus (49) and a precipitating apparatus (63).

The post-combustion furnace (35), for burning the non-condensed smoke, is made of a hollow metal body (36), externally sheathed with sheet (37) and with Inner walls of refractory brick (38), said body is open on its upper face which is connected to a bell-shaped part (39), made of a folded sheet forming a trapezoidal body through which non-condensable fumes After being burned.

The bell (39) in turn has a nozzle (40), where the end of a reaction duct (41) is inserted, it should be noted that the afterburner (35) was mounted on a metal structure (42), similar to a table, with legs (43), which provides height, as the heat recovery duct (15) is connected upstream in the pyrolysis reactor (1), each leg in turn counts at its lower end with a height adjustment screw (44). The post-combustion stage takes advantage of the excess heat generated in the pyrolysis chamber (2) by means of its casing (10) and the heat recovery duct (15), in addition the post-combustion furnace in question has a square perforation (45) on its left side face where the end of the heat recovery duct (15) was connected; a folding door (46), which closes its front face which enables access for maintenance of the afterburner (45); and a second square bore (47), located on its rear face to receive a main injection tube (48).

The steam generator (49) was formed from a cylindrical body (56) which is supplied with water from the municipal grid which was located a couple of meters from the rear side of the afterburner 35, has a water level indicator (50), made of a transparent tube; a hopper (51) at its upper end where calcium hydroxide (CaOH) and sodium bicarbonate (NaCO₂) are added, which are mixed with the water vapor to react with the fumes or crude gases resulting from the non-condensed pyrolysis Which come from the vacuum pump (34) and are burned in the afterburner (35). At the lower end of the steam generator (49) is located a gas inlet pipe (52) for injecting gas from the tank (13) into a burner (not shown) located at the bottom of said generator (49) to generate water vapor therein; while from its upper end there is a tube (53) for the outlet of steam which is connected to a water eliminator (54).

Said water eliminator (54) is located between the afterburner (35) and the steam generator (49), which was connected to three tubes: to the first tube (53) which receives the vapor mixture from Water with CaOH and NaCO₂, and leads it into the eliminator (54); a second tube 57 which conducts the dry steam mixture of water with CaOH and NaCO₂ to the main injection tube (48), which opens into the rear inlet (47) of the afterburner (35); and a third tube (58) which is attached to the underside of the water eliminator (54) and has a valve (60) for discharging the excess water.

The main injection tube (48) was connected to an inlet tube (59) to receive the tube (31) the non-condensed fumes from the vacuum pump (34); said tube (48) was connected to the gas distributing tube (61) from the gas tank (13), when it is required to inject gas into the smoke to be cleaned that is not burning.

A solids precipitator (63) was placed on the face of the furnace (35), which has no perforations; said precipitator has an opening (64) for receiving the flow produced in the furnace (35). The solid precipitator 63 is made of a container composed of a truncated conical folded sheet (65), followed by another cylindrically shaped sheet (66), which has a perforation with a nozzle (67), used to insert the end of a reaction duct (41), a second bore (68′) is located on the upper face of this cylindrical sheet for engaging a chimney (68), through which the free air is expelled from contaminants, while at its lower end the precipitator has a sliding tray (69), which serves to regulate the output of the solid particles formed by combining the pollutant smoke solids with the CaOH and NaCO₂, because at this stage the different salts are condensed into powders and precipitated to the bottom. Finally, this solids precipitator (63) was placed on a metal structure (70), with legs (71) in a rectangular arrangement and a metal ring (72); this structure gives rise to the solids precipitator to connect with the reaction duct (41), which exits above the afterburner (35). Said reaction line (41) is inserted through its left end into the nozzle (40) of the afterburner (35), while its right end is inserted into the nozzle (67) of the precipitating apparatus (63).

The reaction duct (41) is the place where the physico-chemical reactions of the non-condensable fumes already burned, as the temperature of the reactants goes down, that is, that each of the reactions will occur at a different temperature and in consecutive order, in its path between the afterburner (35) and the precipitator (63). In this way, the already condensed non-condensable gases are cleaned of contaminants, where the solid particles are agglomerated using as calcium or sodium binders and are precipitated to the bottom of the precipitating apparatus. In the case of non-metals, such as sulfur, calcium compounds will form and in the case of chlorine it will form a bond with sodium.

Both the heat recovery duct (15) and the reaction duct (41) have in their interior a gate (73), provided with a lever (74), which allows them to open or close to regulate the quantity of fluids.

The control panel (19), the reduction motor (6), the vacuum pump (34), and the cooling tower (30) of the prototype are supplied with electric power from the mains.

### Example 2

Products Obtained from the Pyrolysis of the Plant Described in Example 1.

The main products obtained were: steel tire strings, heavy and light hydrocarbon oils, gas, carbon black and clean air.

The steel can be re-melted, oils can be reused as diesel or fuel, carbon black as a coloring pigment or to firm the rubber.

It is to be mentioned that this equipment and pyrolysis plant, described, are merely an example for carrying out the process of the present invention, and therefore should not be considered as unique for such an embodiment, since such a process may be carried out with other systems and plants for treatment of materials by combustion/incineration, thermolysis, pyrolysis and gasification.

1. A process for cleaning non-condensable pollutant fumes, produced by a combustion, wherein the process comprises:
i) concentrate non-condensable polluting fumes;
ii) mixing the contaminating fumes with an alkaline mixture and steam with the aid of a steam generating apparatus;
iii) injecting the above mixture into a combustion furnace (35),
iv) incinerate the mixture in the combustion furnace;
v) conducting the resulting combustion flow through a duct without heat, where the solid particles that accompany the polluting fumes, will be united to the solid particles of the alkaline mixture, thus cleaning the fumes;
vi) separating the agglomerates formed in the previous step from the gaseous part with the aid of a solids precipitating apparatus (63); where the gaseous part is released into the environment; y
vii) to recover precipitated agglomerates.

2. The process of the preceding claim, wherein the post-combustion furnace (35) comprises:
i) a body (36) made of materials resistant to combustion and/or incineration temperatures, for example of refractory brick, the walls of which are externally sheathed with metal sheets (37) and the upper face is open;
ii) a bell-shaped part (39), with an upper aperture (40), made of metal foil, seals the upper face of the furnace body (36);
iii) a perforation (45) is provided on one of the side faces of the body (36) for receiving the external heat generated by a source of pollutant fumes covered by a housing (10);
iv) a duct (15) which is connected in the perforation (45) and a bore (14) having the casing (10), to convey concentrated heat in said casing (10) to the interior of the afterburner (35);
v) a perforation (47) on another of the side faces of the body (36), to receive the non-condensed polluting fumes, produced combustion; and
vi) a hinged door (46) is provided to seal a fully open side face of the body (36).

3. The process of the preceding claim, wherein the afterburner (35) further comprises a structure (42), on which said afterburner (35) is placed so that it is at a suitable height and interacts correctly with the others components.

4. The process of the preceding claim, wherein the structure further comprises means (44) for height regulation.

5. The process according to claim 1, wherein the steam generator (49) comprises:
i) a cylindrical body (56) disposed vertically;
ii) ducts are added to the cylindrical body (56) to receive water from some water source;
iii) a water level indicator (50) is placed on the cylindrical body (56);
iv) a hopper (51) at the upper end of the body (56), whereby the alkaline mixture;
v) a burner is provided in the lower part of the body (56), to produce heat and generate water vapor; and
vi) a tube (53), connected in the upper part of the body (56), moves the steam mixed with the alkaline mixture, towards the water eliminating apparatus (54).

6. The process of claim 1, wherein the alkaline mixture comprises: calcium hydroxide (CaOH) and sodium bicarbonate (NaCO₂) or caustic soda (NaOH).

7. The process according to the preceding claim, wherein the mixture is a combination of calcium hydroxide (CaOH) and sodium bicarbonate (NaCO₂).

8. The process of the preceding claim, wherein the concentration of calcium hydroxide (CaOH) and sodium bicarbonate (NaCO₂) is 3:1.

9. The process according to claim 1, wherein the water eliminating apparatus comprises:
i) a closed container, which in its upper part receives the tube (53) of the vapor generator apparatus (49);
ii) a vertical tube (58) with a valve (60) is provided at the bottom of the closed container to allow excess water to flow out; and
iii) a tube (57) is added to the top of the closed container to conduct the fraction still remaining in water vapor mixed with the alkaline mixture to the line fed to the furnace (35).

10. The process according to claim 1, wherein the pipe network connecting the afterburner (35), water eliminating apparatus (54), steam generating apparatus (49), the source of non-condensable contaminant fumes, and a source of gas, comprises:
i) a main injection tube (48) is positioned in a lateral perforation (47) of the body (36) of the furnace (35); in said tube (48) the tube (57);
ii) a pipe (31) and (59) which is connected between the main injection pipe (48) prior to connection of the pipe (57) and the source of non-condensable contaminant fumes;
iii) a pipe (61) coming from the gas source (13) bifurcates; where a branch is connected in the main tube (48) to inject combustible gas into the polluting fumes, to make them combustible; and the second branch is connected to;
iv) a tube (52) located in the burner of the steam generating apparatus (49).

11. The process according to the preceding claim, wherein the source of non-condensable contaminating fumes is a combustion/incineration, gasification, thermolysis and/or pyrolysis.

12. The process of the preceding claim, wherein the source is pyrolysis.

13. The process according to claim 8, wherein the gas source is a fuel gas tank (13).

14. The process as claimed in claim 1, wherein the precipitating apparatus (63) comprises:
i) a lower truncated conical body (65) which is hollow and open in its two apertures, where its major aperture is projected upwardly, to position a cylindrical body (66) open on its underside and closed on its upper face, but with a central perforation (68′);
ii) a chimney (68) is placed in the central bore (68′);
iii) a side mouth (64) is provided on the side face of the cylindrical body (66), preferably at the top, by this mouth (64) where the reaction duct (41) and the upper opening (40) are connected, from the oven (35); and
iv) a structure, wherein said solids precipitator (63) is placed, to have a certain height and allow the precipitation of particles by gravity.

15. The process according to claim 1, wherein the heat recovery duct (15) and the reaction duct (41) further comprise in its interior a damper (73), with a lever (74), which opens or closes to regulate the amount of fluids.
